(19) United States
(12) Patent Application Publication
(10) Pub. No.: US 2026/0195256 A1
(43) Pub. Date: Jul. 9, 2026

(54) SYSTEM AND METHOD TO PROVISION STORAGE USING NON-CONTIGUOUS STORAGE SPACE

(71) Applicant: Microchip Technology Incorporated, Chandler, AZ (US)

(72) Inventor: Anand Nagarajan, Bengaluru (IN)

(73) Assignee: Microchip Technology Incorporated, Chandler, AZ (US)

(21) Appl. No.: 19/070,586

(22) Filed: Mar. 5, 2025

(30) Foreign Application Priority Data
Jan. 3, 2025 (IN) 202511000818

(51) Int. Cl. G06F 12/02

(52) U.S. Cl. CPC G06F 12/023

(57) ABSTRACT

Systems and methods to chain smaller non-contiguous free chunks in non-volatile memory to form a logical storage volume which is greater than any of the constituent free chunks. These comprise: identifying a plurality of free chunks of available storage in a storage array; identifying a start block offset and a number of blocks of respective ones of the plurality of free chunks; creating a logical volume by chaining the plurality of free chunks, wherein blocks are provisioned in the logical volume beginning at a first free chunk start block offset for a first free chunk number of blocks, continuing to provision blocks in the logical volume at a second free chunk start block offset for a second free chunk number of blocks, and continuing to provision blocks in the logical volume until the plurality of free chunks are provisioned in the logical volume.

### RELATED PATENT APPLICATION

This application claims priority to commonly owned Indian Patent Application No. 202511000818 filed Jan. 3, 2025, the entire contents of which are hereby incorporated by reference for all purposes.

### TECHNICAL FIELD

The present disclosure relates to non-volatile storage memory, in particular, chaining smaller non-contiguous free chunks in non-volatile storage memory to form a logical storage volume which is larger than any of the constituent free chunks.

### BACKGROUND

Non-volatile storage media may be combined using data protection mechanisms such as redundant array of independent disks (RAID) or erasure coding technology to achieve data redundancy and reliability. RAID saves data in multiple places so that if one or more disks fail, copies of the data is on other disks. There are RAID levels which provide a failure tolerance of up to two disks. Even nested RAID levels assure reconstruct ability for up to two disks based on the failure tolerance of a leg corresponding to the primary RAID level. RAID implementations offer high performance levels owing to degree of parallelism which can be obtained when multiple media are used to store data. Storage media include: hard disk drives, solid state disk drives, tape drives, and optical drives, without limitation.

A volume, a logical drive, a RAID volume, or an erasure coded volume is a logical abstraction of storage provisioned from a storage array constituted by a set of physical disks. The logical volume presents an amount of storage space to the host for data storage. The storage space is physically comprised of part of the storage space provided by its constituent physical disks. The capacity of a volume is often less than the sum of capacity of its constituent physical disks owing to the additional redundancy introduced for fault tolerance. Host data written on the volume means that the host has written bytes of data starting at a logical block address of the space provided by the volume. The actual data may reside/span across one of more physical disks and physical block addresses.

A storage controller is connected to the set of physical disks to provision storage.

When multiple logical storage volumes are provisioned in a storage array, free space gaps get created when one or more volumes are deleted from the middle. These free spaces can be utilized fully if the requested free space is smaller than the largest contiguous free space chunk or if the non-contiguous free spaces are combined by moving them, to form a larger contiguous block.

Data movement to combine all the non-contiguous free space chunks, is a time consuming and risky operation which has an overall impact on the storage system performance.

There is a need for a system that utilizes free space gaps in non-volatile storage arrays without data movement.

### SUMMARY

Aspects provide a method to chain smaller non-contiguous free chunks in non-volatile storage to form a logical storage volume which is larger than any of the constituent free chunks.

According to an aspect, there is provided a method comprising: identifying a plurality of free chunks of available storage of a storage array; identifying a start block offset and a number of blocks of respective ones of the plurality of free chunks; creating a logical volume by chaining the plurality of free chunks, wherein blocks are provisioned in the logical volume beginning at a first free chunk start block offset for a first free chunk number of blocks, continuing to provision blocks in the logical volume at a second free chunk start block offset for a second free chunk number of blocks, and continuing to provision blocks in the logical volume until the plurality of free chunks are provisioned in the logical volume.

An aspect as in the preceding paragraph provides, determining whether a sum total of free chunk number of blocks of the storage array is greater than a requested number of blocks to be provisioned.

An aspect as in one of the preceding two paragraphs provides, provisioning the requested number of blocks for the logical volume from the storage array when the sum total is determined to be greater than the requested number of blocks.

An aspect as in one of the preceding three paragraphs provides, comprising determining whether a sum of the number of blocks of respective ones of the plurality of free chunks of the storage array is greater than a requested number of blocks to be provisioned.

An aspect as in one of the preceding four paragraphs provides, comprising provisioning the requested number of blocks for the logical volume from the storage array when the sum is determined to be greater than the requested number of blocks

An aspect as in one of the preceding five paragraphs provides receiving a request to access the logical volume.

An aspect as in one of the preceding six paragraphs provides finding the first free chunk start block offset of the logical volume.

An aspect as in one of the preceding seven paragraphs provides accessing blocks of the logical volume.

An aspect as in one of the preceding eight paragraphs provides scaling up the size of the logical volume by provisioning a third free chunk of available storage and appending the third free chunk to the logical volume.

According to an aspect, there is provided a device comprising: an identifier circuit operable to identify a plurality of free chunks of available storage in a storage array; an identifier circuit operable to identify a start block offset and a number of blocks of respective ones of the plurality of free chunks; and a logical volume circuit operable to: chain respective ones of the plurality of free chunks to create a logical volume, provision blocks of the logical volume beginning at a first free chunk start block offset for a first free chunk number of blocks, continue to provision blocks of the logical volume at the second free chunk start block offset for a second free chunk number of blocks, and continue to provision blocks of the logical volume until the plurality of free chunks are provisioned in the logical volume.

An aspect as in the preceding paragraph provides a first determining circuit operable to determine whether a sum total of free chunk number of blocks of the storage array is greater than a requested number of blocks to be provisioned.

An aspect as in one of the preceding two paragraphs provides a first provisioning circuit operable to provision the requested number of blocks for the logical volume from the storage array when the sum total is determined to be greater than the requested number of blocks.

An aspect as in one of the preceding three paragraphs provides, a second determining circuit operable to determine whether a sum of the number of blocks of respective ones of the plurality of free chunks of the storage array is greater than a requested number of blocks to be provisioned.

An aspect as in one of the preceding four paragraphs provides, a second provisioning circuit operable to provision the requested number of blocks for the logical volume from the storage array when the sum is determined to be greater than the requested number of blocks.

An aspect as in one of the preceding five paragraphs provides, a receiving circuit operable to receive a request to access the logical volume.

An aspect as in one of the preceding six paragraphs provides, a finding circuit operable to find the first configured chunk start block offset of the logical volume.

An aspect as in one of the preceding seven paragraphs provides, an accessing circuit operable to access blocks of the logical volume.

According to an aspect, there is provided a system comprising: a first storage media; a second storage media; a processor; and a memory comprising instructions, which when executed by the processor, to configure the processor to: identify a plurality of free chunks of available storage in a storage array; identify a start block offset and a number of blocks of respective ones of the plurality of free chunks; chain respective ones of the plurality of free chunks to create a logical volume; provision blocks of the logical volume beginning at a first free chunk start block offset for a first free chunk number of blocks; continue to provision blocks of the logical volume at the second free chunk start block offset for a second free chunk number of blocks; and continue to provision blocks of the logical volume until the plurality of free chunks are provisioned in the logical volume.

An aspect as in the preceding paragraph provides a memory comprising instructions, which when executed by the processor, to configure the processor to: determine whether a sum total of free chunk number of blocks of the storage array is greater than a requested number of blocks to be provisioned; and if the sum total is greater than a requested number of blocks, provision the requested number of blocks for the logical volume from the storage array.

An aspect as in one of the preceding two paragraphs provides, a memory comprising instructions, which when executed by the processor, to configure the processor to: determine whether a sum of the number of blocks of respective ones of the plurality of free chunks of the storage array is greater than a requested number of blocks to be provisioned; and if the sum is determined to be greater than the requested number of blocks, provision the requested number of blocks for the logical volume from the storage array.

An aspect as in one of the preceding three paragraphs provides a memory comprising instructions, which when executed by the processor, to configure the processor to: receive a request to access the logical volume; find the starting block offset of the request in the chunks that constitute the logical volume; and accessing requested blocks of the logical volume spanning one or more chunks.

### BRIEF DESCRIPTION OF THE DRAWINGS

A more complete understanding of the disclosure and the advantages thereof may be acquired by referring to the following description, taken in conjunction with the accompanying drawings and wherein:

FIG. 1 shows a block diagram of a system for storage space utilization.

FIG. 2 shows class diagrams of a volume, chunk, and storage media source structures for chaining chunks of free space into a logical volume.

FIGS. 3A and 3B show a block diagram of a chained logical volume. Three different storage media provide physical storage for a logical volume.

FIG. 4 shows a flow chart of a provisioning flow diagram.

FIGS. 5A and 5B show a flow chart of an input/output I/O processing flow diagram.

FIG. 6 is a block diagram of circuitry that may be used to implement various functions, operations, acts, processes, and methods disclosed herein.

The drawings accompanying and forming part of this specification are included to depict certain aspects of the disclosure. The reference number for any illustrated element that appears in multiple different figures has the same meaning across the multiple figures, and the mention or discussion herein of any illustrated element in the context of any particular figure also applies to each other figure, if any, in which that same illustrated element is shown. The features illustrated in the drawings are not necessarily drawn to scale. The features illustrated in the drawings are not necessarily drawn to scale.

### DESCRIPTION

Aspects provide a method to chain smaller non-contiguous free chunks in non-volatile storage memory to form a logical storage volume which is larger than any of the constituent free chunks of a storage array.

Aspects may improve storage space utilization when there are gaps in the storage array. Aspects may negate performance impacts owing to space consolidation. Aspects may reduce internal data movement to consolidate all the free spaces together.

Aspects may provide a way to combine non-contiguous blocks of space from an array of individual physical storage media to form a logical storage volume. This may be done by aggregating and maintaining non-contiguous blocks of free space as a chain, to provide a logical storage volume.

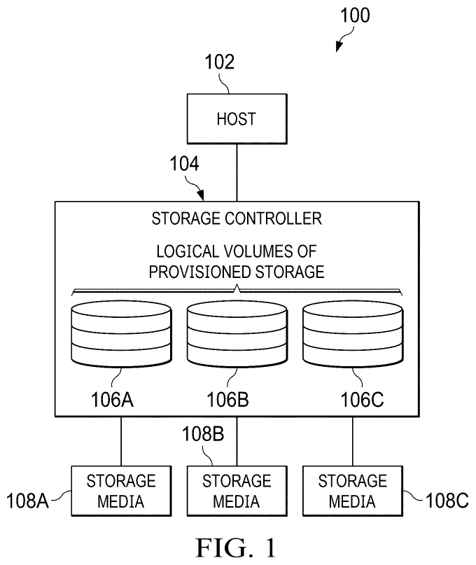

FIG. 1 shows a block diagram of a system for storage space utilization. The system 100 has a host 102, a storage controller 104, and storage media 108A-108C. The storage controller 104 may be in hardware or software or a combination of hardware and software. The storage controller 104 may be used to provision the storage media into logical volumes 106A-106C.

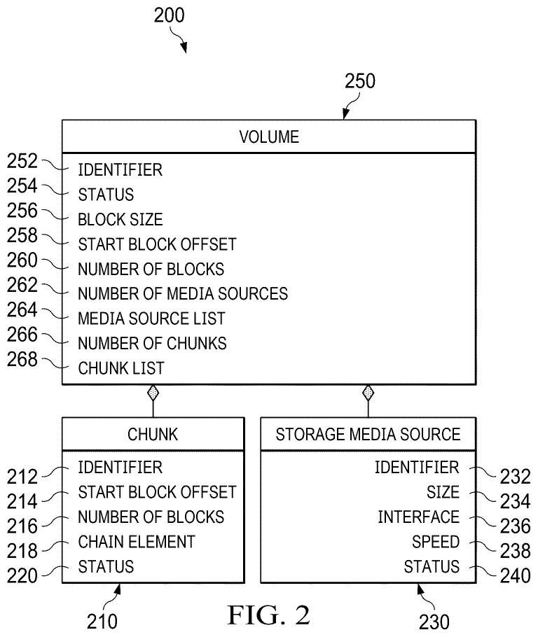

FIG. 2 shows a block diagram of a volume structure 200 for chaining chunks of free space into a logical volume. An individual chunk 210 of free space may include: an identifier 212, start block offset 214, number of blocks 216, chain element 218, and status 220. A storage media source 230 may include: an identifier 232, size 234, interface 246, speed 238, and status 240. A logical volume 250 may include: an identifier 252, status 254, block size 256, start block offset 258, number of blocks 260, number of media sources 262, media source lists 264, number of chunks 266, and a chunk list 268.

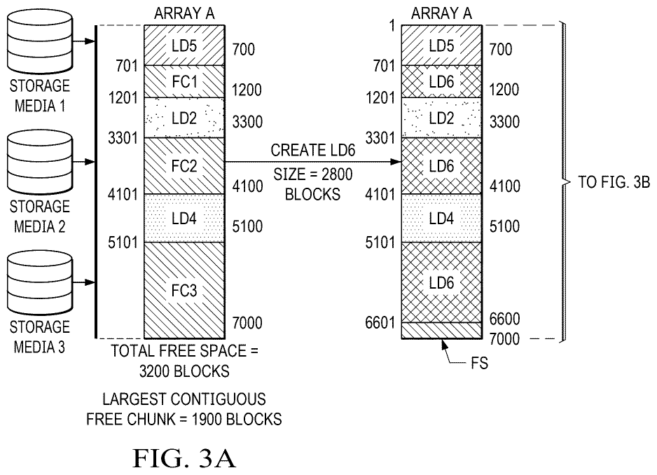

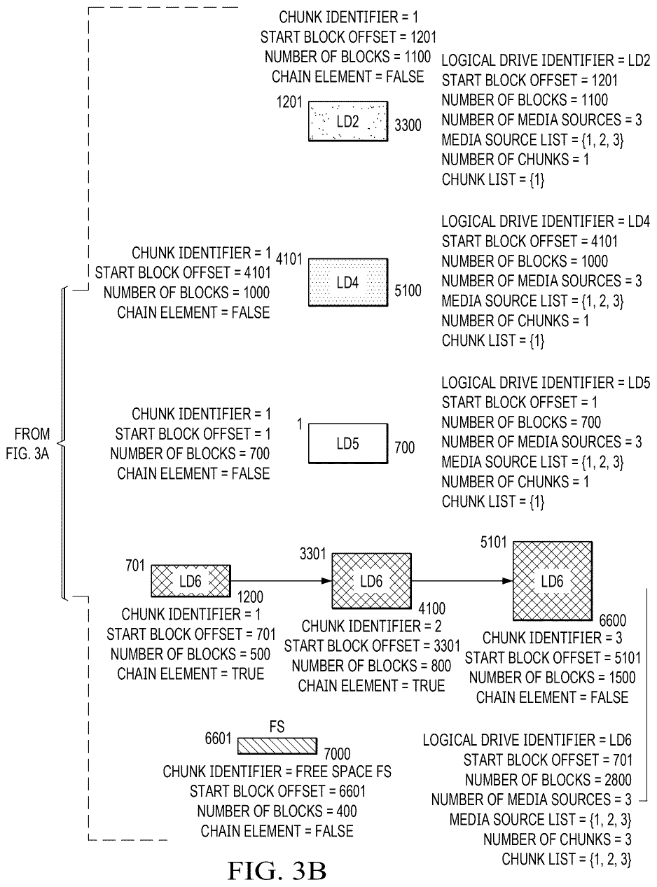

FIGS. 3A and 3B show a block diagram of a chained logical volume. Three different storage media (storage media 1, storage media 2, and storage media 3) provide physical storage for a storage array A. The storage array (Array A) has: a logical device or a logical volume LD5 at blocks 1-700; a free chunk FC1 at blocks 701-1200; a logical device LD2 at blocks 1201-3300; a free chunk FC2 at blocks 3301-4100; a logical device LD4 at blocks 4101-5100; and a free chunk FC3 at blocks 5101-7000. Thus, storage array (Array A) has a total free space of 3200 blocks, and the largest contiguous free space chunk is 1900 blocks at FC3.

A storage controller may provision logical volume from the storage array (Array A) to present to a host a first logical volume having: identifier=LD2; start block offset=1201; number of blocks=1100; number of media sources=3; media source list={1, 2, 3}; number of chunks=1; and chunk list={1}. This LD2 logical volume is based on a chunk having: identifier=1; start block offset=1201; number of blocks=1100; and chain element=“false” because this chunk is the end of a chain.

The storage controller may also provision logical volume from the storage Array A to present to a host a second logical volume having: identifier=LD4; start block offset=4101; number of blocks=1000; number of media sources=3; media source list={1, 2, 3}; number of chunks=1; and chunk list={1}. This LD4 logical volume is based on a chunk having: identifier=1; start block offset=4101; number of blocks=1000; and chain element=“false” because this chunk is the end of a chain.

The storage controller may also provision logical volume from the storage Array A to present to a host a third logical volume having: identifier=LD5; start block offset=1; number of blocks=700; number of media sources=3; media source list={1, 2, 3}; number of chunks=1; and chunk list={1}. This LD5 logical volume is based on a chunk having: identifier=1; start block offset=1; number of blocks=700; and chain element=“false” because this chunk is the end of a chain.

The storage controller may also provision logical volume from the storage Array A to present to a host a fourth logical volume having: identifier=LD6; start block offset=701; number of blocks=2800; number of media sources=3; media source list={1, 2, 3}; number of chunks=3; and chunk list={1, 2, 3}. This LD6 logical volume is based on three chunks. The first chunk spans logical blocks 0-500 of logical volume LD6. The first chunk has: identifier=1; start block offset=701; number of blocks=500; and chain element=“true” because this chunk is not the end of the chain. The second chunk spans logical blocks 501-1300 of logical volume LD6. The second chunk has: identifier=2; start block offset=3301; number of blocks=800; and chain element=“true” because this chunk is not the end of the chain. The third chunk spans logical blocks 1301-2800 of logical volume LD6. The third chunk has: identifier=3; start block offset=5101; number of blocks=1500; and chain element=“false” because this chunk is the end of the chain.

The storage controller may also maintain free spaces in the storage Array A, which are hidden from the host. For example, a free space may have: identifier=free space FS; start offset block=6601; number of blocks=400; and chain element=“false” because this chunk is the end of the chain.

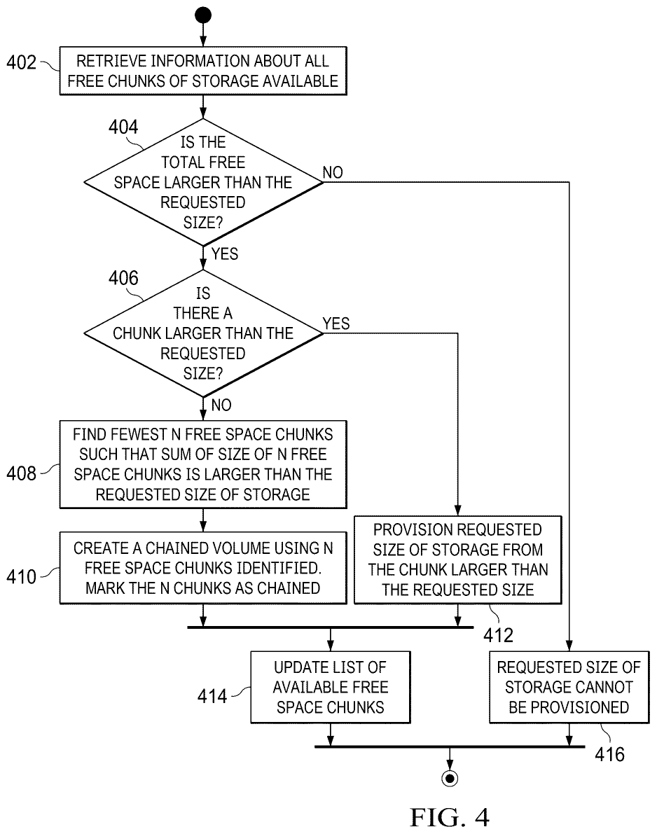

FIG. 4 shows a flow chart of a provisioning flow diagram. Information about all the free chunks of storage available in the storage array is retrieved 402. It is determined 404 whether the total free space is larger than the requested size. If NO, the free space is not larger than the requested size, then the requested size of storage cannot be provisioned 416. If YES, the free space is larger than the requested size, then it is determined 406 whether there is a chunk larger than the requested size. If NO, there is not a chunk larger than the requested size, then the fewest N free space chunks are found 408 such that the sum of size of N free space chunks is larger than the requested size of storage. A chained volume is created 410 using N free space chunks identified and the N chunks are marked as chained. If YES, there is a chunk larger than the requested size, then the requested size of storage is provisioned 412 from the chunk larger than the requested size. Whether there is a chunk larger than the requested size or not, the list of available free space chunks is updated 414.

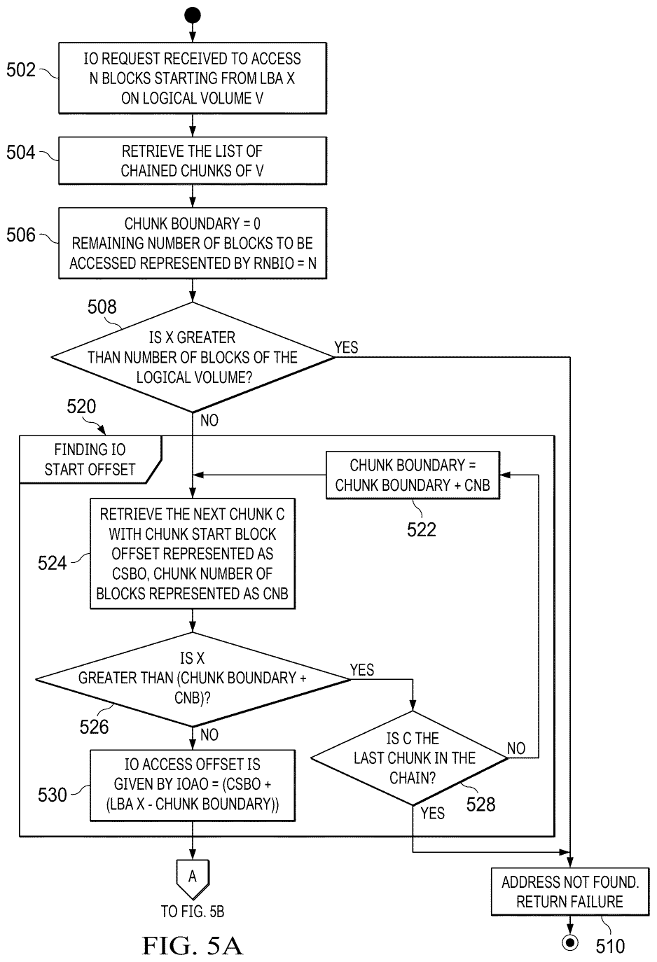

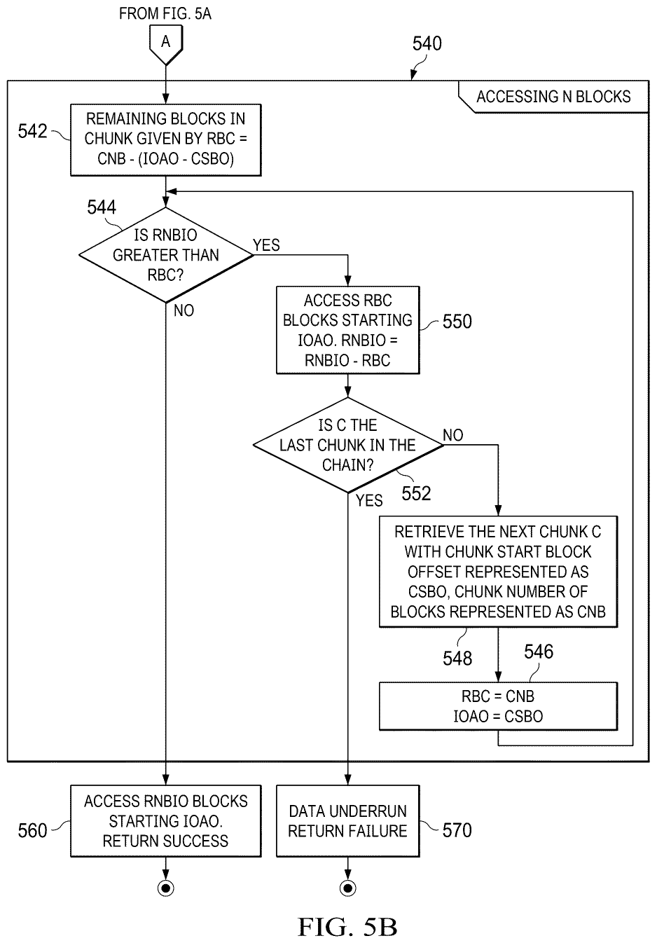

FIGS. 5A and 5B show a flow chart of an input/output I/O processing flow diagram. An input/output IO request is received 502 to access a number N of blocks starting from block X on a logical volume V. The list of chained chunks of V is retrieved 504. The chunk boundary is set 506 to zero (0) and the remaining number of blocks to be accessed represented by RNBIO is set 506 to N. It is determined 508 whether X is greater than the number of blocks of the logical volume V. If YES, X is greater than the number of blocks of the logical volume V, then the requested address is not found and a failure is returned 510. If NO, X is not greater than the number of blocks of the logical volume V, then the IO start offset is found 520.

The IO start offset is found 520 by a subroutine (Finding IO Start Offset). The next chunk C is retrieved 524, with chunk start block offset represented as CSBO and the chunk number of blocks represented as CNB. It is determined 526 whether X is greater than the chunk boundary plus the chunk number of blocks (CNB). If YES, X is greater than the chunk boundary plus the chunk number of blocks (CNB), then it is determined 528 whether C is the last chunk in the chain. If YES, C is the last chunk in the chain, then the requested address is not found and a failure is returned 510. If NO, C is not the last chunk in the chain, then the chunk boundary is set 522 to be equal to the chunk boundary plus the chunk number of blocks CNB. Again, the next chunk C is retrieved 524 and the finding IO start offset subroutine 520 is repeated until either: (1) X is determined 526 to be greater than the chunk boundary plus the chunk number of blocks CNB; or (2) C is determined 528 to be the last chunk in the chain.

If X is determined 526 to be greater than the chunk boundary plus the chunk number of blocks CNB, then process flow moves to an Accessing N Blocks subroutine where N blocks are accessed 540. The remaining blocks in chunk RBC is set 542 to be equal to chunk number of blocks CNB minus the IO access offset IOAO minus the chunk start block offset CSBO. It is determined 544 whether the remaining number of blocks to be accessed RNBIO is greater than the remaining blocks in chunk RBC. If NO, RNBIO is not greater than RBC, then the remaining number of blocks to be accessed RNBIO are accessed 560 starting at the IO access offset IOAO and a “success” is returned. If YES, RNBIO is greater than RBC, then the remaining blocks in chunk RBC are accessed 550 starting at the IO access offset IOAO, and the remaining number of blocks to be accessed RNBIO is incremented to be equal to RNBIO minus the remaining blocks in chunk RBC. It is determined 552 whether C is the last chunk in the chain. If YES, C is the last chunk in the chain, then the data is underrun 570 and a “failure” is returned. If NO, C is not the last chunk in the chain, then the next chunk C is retrieved 548 with chunk start block offset represented as CSBO and the chunk number of blocks is represented as CNB. The remaining blocks in chunk RBC is set 546 to be equal to chunk number of blocks CNB and IP access offset IOAO is set 546 to be equal to chunk start block offset CSBO. Again, it is determined 544 whether the remaining number of blocks to be accessed RNBIO is greater than the remaining blocks in chunk RBC and the Accessing N Blocks subroutine 540 is repeated until either: (1) RNBIO is not determined 544 to be greater than RBC; or (2) C is determined 552 to be the last chunk in the chain.

Aspects provide a method to be used when existing logical volumes are to be expanded for scaling up the volume size. The requested additional size of logical volume can be provisioned using free space chunks available on the storage array which may thereafter be appended to the existing chain of chunks of the logical volume. The algorithm for accessing IO on a chained volume indicated in FIG. 5 works for such expanded or scaled up logical volumes. An aspect provides a method comprising: identifying first and second free chunks of available storage; identifying a first free chunk start block offset and a first free chunk number of blocks; identifying a second free chunk start block offset and a second free chunk number of blocks; creating a logical volume by chaining the first and second free chunks, wherein the logical volume begins at the first free chunk start block offset and has a logical volume number of blocks equal to the first free chunk number of blocks plus the second free chunk number of blocks; and scaling up the size of the logical volume by provisioning a third free chunk of available storage and appending the third free chunk to the logical volume.

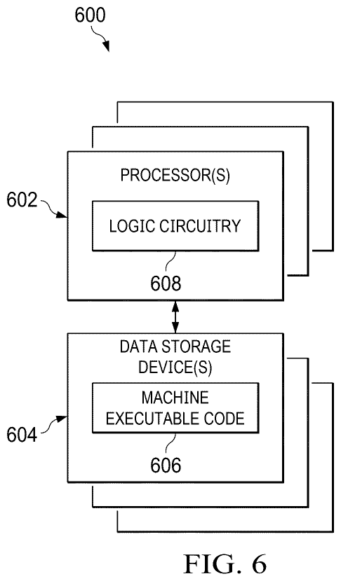

FIG. 6 is a block diagram of circuitry 600 that, in some aspects, may be used to implement various functions, operations, acts, processes, and/or methods disclosed herein. The circuitry 600 includes one or more processors 602 (sometimes referred to herein as “processors 602”) operably coupled to one or more data storage devices (sometimes referred to herein as “storage 604”). The storage 604 includes machine executable code 606 stored thereon and the processors 602 include logic circuitry 608. The machine executable code 606 includes information describing functional elements that may be implemented by (e.g., performed by) the logic circuitry 608. The logic circuitry 608 is adapted to implement (e.g., perform) the functional elements described by the machine executable code 606. The circuitry 600, when executing the functional elements described by the machine executable code 606, may be considered as specific purpose hardware configured for carrying out functional elements disclosed herein. In some aspects the processors 602 may perform the functional elements described by the machine executable code 606 sequentially, concurrently (e.g., on one or more different hardware platforms), or in one or more parallel process streams.

When implemented by logic circuitry 608 of the processors 602, the machine executable code 606 adapts the processors 602 to perform operations of aspects disclosed herein. For example, the machine executable code 606 may adapt the processors 602 to perform at least a portion or a totality of the storage space utilization methods of FIGS. 3-5. As another example, the machine executable code 606 may adapt the processors 602 to perform at least a portion or a totality of the operations discussed for the storage space utilization circuit of FIGS. 1 and 2. As a specific, non-limiting example, the machine executable code 606 may adapt the processors 602 to perform at least a portion of the storage space utilization operations discussed herein.

The processors 602 may include a general purpose processor, a specific purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a specific-purpose computer while the general-purpose computer is operable to execute functional elements corresponding to the machine executable code 606 (e.g., software code, firmware code, hardware descriptions) related to aspects of the present disclosure. It is noted that a general-purpose processor (may also be referred to herein as a host processor or simply a host) may be a microprocessor, but in the alternative, the processors 602 may include any conventional processor, controller, microcontroller, or state machine. The processors 602 may also be implemented as a combination of computing devices, such as a combination of a DSP and a microprocessor, a plurality of microprocessors, one or more microprocessors in conjunction with a DSP core, or any other such configuration.

In some aspects the storage 604 includes volatile data storage (e.g., random-access memory (RAM)), non-volatile data storage (e.g., Flash memory, a hard disc drive, a solid state drive, erasable programmable read-only memory (EPROM), without limitation). In some aspects the processors 602 and the storage 604 may be implemented into a single device (e.g., a semiconductor device product, a system on chip (SOC), without limitation). In some aspects the processors 602 and the storage 604 may be implemented into separate devices.

In some aspects the machine executable code 606 may include computer-readable instructions (e.g., software code, firmware code). By way of non-limiting example, the computer-readable instructions may be stored by the storage 604, accessed directly by the processors 602, and executed by the processors 602 using at least the logic circuitry 608. Also by way of non-limiting example, the computer-readable instructions may be stored on the storage 604, transferred to a memory device (not shown) for execution, and executed by the processors 602 using at least the logic circuitry 608. Accordingly, in some aspects the logic circuitry 608 includes electrically configurable logic circuitry 608.

In some aspects the machine executable code 606 may describe hardware (e.g., circuitry) to be implemented in the logic circuitry 608 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog™, SystemVerilog™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 608 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some aspects, the machine executable code 606 may include an HDL, an RTL, a GL description, a mask level description, other hardware description, or any combination thereof.

In aspects where the machine executable code 606 includes a hardware description (at any level of abstraction), a system (not shown, but including the storage 604) may be operable to implement the hardware description described by the machine executable code 606. By way of non-limiting example, the processors 602 may include a programmable logic device (e.g., an FPGA or a PLC) and the logic circuitry 608 may be electrically controlled to implement circuitry corresponding to the hardware description into the logic circuitry 608. Also, by way of non-limiting example, the logic circuitry 608 may include hard-wired logic manufactured by a manufacturing system (not shown, but including the storage 604) according to the hardware description of the machine executable code 606.

Regardless of whether the machine executable code 606 includes computer-readable instructions or a hardware description, the logic circuitry 608 is adapted to perform the functional elements described by the machine executable code 606 when implementing the functional elements of the machine executable code 606. It is noted that although a hardware description may not directly describe functional elements, a hardware description indirectly describes functional elements that the hardware elements described by the hardware description are capable of performing.

Although examples have been described above, other variations and examples may be made from this disclosure without departing from the spirit and scope of these disclosed examples.

What is claimed is:

1. A method comprising:
identifying a plurality of free chunks of available storage of a storage array;
identifying a start block offset and a number of blocks of respective ones of the plurality of free chunks;
creating a logical volume by chaining the plurality of free chunks, wherein blocks are provisioned in the logical volume beginning at a first free chunk start block offset for a first free chunk number of blocks, continuing to provision blocks in the logical volume at a second free chunk start block offset for a second free chunk number of blocks, and continuing to provision blocks in the logical volume until the plurality of free chunks are provisioned in the logical volume.

2. The method as in claim 1, comprising determining whether a sum total of free chunk number of blocks of the storage array is greater than a requested number of blocks to be provisioned.

3. The method as in claim 2, comprising provisioning the requested number of blocks for the logical volume from the storage array when the sum total is determined to be greater than the requested number of blocks.

4. The method as in claim 1, comprising determining whether a sum of the number of blocks of respective ones of the plurality of free chunks of the storage array is greater than a requested number of blocks to be provisioned.

5. The method as in claim 4, comprising provisioning the requested number of blocks for the logical volume from the storage array when the sum is determined to be greater than the requested number of blocks.

6. The method as in claim 1, comprising receiving a request to access the logical volume.

7. The method as in claim 6, comprising finding the first free chunk start block offset of the logical volume.

8. The method as in claim 6, comprising accessing blocks of the logical volume.

9. The method as in claim 1, comprising scaling up a size of the logical volume by provisioning a third free chunk of available storage and appending the third free chunk to the logical volume.

10. A device comprising:
an identifier circuit operable to identify a plurality of free chunks of available storage in a storage array;
an identifier circuit operable to identify a start block offset and a number of blocks of respective ones of the plurality of free chunks;
and
a logical volume circuit operable to:
chain respective ones of the plurality of free chunks to create a logical volume,
provision blocks of the logical volume beginning at a first free chunk start block offset for a first free chunk number of blocks,
continue to provision blocks of the logical volume at a second free chunk start block offset for a second free chunk number of blocks,
and continue to provision blocks of the logical volume until the plurality of free chunks are provisioned in the logical volume.

11. The device as in claim 10, comprising a first determining circuit operable to determine whether a sum total of free chunk number of blocks of the storage array is greater than a requested number of blocks to be provisioned.

12. The device as in claim 11, comprising a first provisioning circuit operable to provision the requested number of blocks for the logical volume from the storage array when the sum total is determined to be greater than the requested number of blocks.

13. The device as in claim 10, comprising a second determining circuit operable to determine whether a sum of the number of blocks of respective ones of the plurality of free chunks of the storage array is greater than a requested number of blocks to be provisioned.

14. The device as in claim 13, comprising a second provisioning circuit operable to provision the requested number of blocks for the logical volume from the storage array when the sum is determined to be greater than the requested number of blocks.

15. The device as in claim 10, comprising a receiving circuit operable to receive a request to access the logical volume.

16. The device as in claim 15, comprising a finding circuit operable to find the first free chunk start block offset of the logical volume.

17. The device as in claim 15, comprising an accessing circuit operable to access blocks of the logical volume.

18. A system comprising:
a first storage media;
a second storage media;
a processor; and
a memory comprising instructions, which when executed by the processor, to configure the processor to:
identify a plurality of free chunks of available storage in a storage array;
identify a start block offset and a number of blocks of respective ones of the plurality of free chunks;
chain respective ones of the plurality of free chunks to create a logical volume;
provision blocks of the logical volume beginning at a first free chunk start block offset for a first free chunk number of blocks;
continue to provision blocks of the logical volume at a second free chunk start block offset for a second free chunk number of blocks; and
and continue to provision blocks of the logical volume until the plurality of free chunks are provisioned in the logical volume.

19. The system as in claim 18, comprising a memory comprising instructions, which when executed by the processor, to configure the processor to:
determine whether a sum total of free chunk number of blocks of the storage array is greater than a requested number of blocks to be provisioned; and
if the sum total is greater than a requested number of blocks, provision the requested number of blocks for the logical volume from the storage array.

20. The system as in claim 18, comprising a memory comprising instructions, which when executed by the processor, to configure the processor to:
determine whether a sum of the number of blocks of respective ones of the plurality of free chunks of the storage array is greater than a requested number of blocks to be provisioned; and
if the sum is determined to be greater than the requested number of blocks, provision the requested number of blocks for the logical volume from the storage array.

21. The system as in claim 18, comprising a memory comprising instructions, which when executed by the processor, to configure the processor to:
receive a request to access the logical volume;
find the starting block offset of the request in the chunks that constitute the logical volume; and
accessing requested blocks of the logical volume spanning one or more chunks.
